(19) United States
(12) Patent Application Publication
(10) Pub. No.: US 2026/0238283 A1
(43) Pub. Date: Aug. 13, 2026

(54) CONFIGURING A WIRELESS DEVICE WITH A CSI PAYLOAD SIZE

(71) Applicant: Telefonaktiebolaget LM Ericsson (publ), Stockholm (SE)

(72) Inventors: Chandan PRADHAN, Kanagawa (JP); Xinlin ZHANG, Västra Frölunda (SE); Ilmiawan SHUBHI, Malmö (SE); Emil RINGH, Solna (SE)

(21) Appl. No.: 19/156,510

(22) PCT Filed: Feb. 1, 2024
(86) PCT No.: PCT/SE2024/050088

§ 371 Date: Aug. 14, 2025

Related U.S. Application Data
(60) Provisional application No. 63/485,341, filed on Feb. 16, 2023.

(51) Int. Cl. H04B 7/06; H04L 41/16; H04W 72/21

(52) U.S. Cl. CPC H04B 7/0626; H04L 41/16; H04W 72/21

(57) ABSTRACT

A method for a WD (22) is disclosed. The method includes receiving, from a network node (46), a configuration for a CSI payload size and transmitting, to the network node, a CSI report, wherein the CSI report has been generated by omitting a plurality of bits according to an omission rule such that the CSI report has a size less than or equal to the CSI payload size. The WD, the network node, a method performed by the network node and a computer program and a computer program product each for the WD and the network node are also disclosed.

### TECHNICAL FIELD

The present disclosure relates to wireless communications, and in particular, to modifying artificial intelligence (AI)-based channel state information (CSI) feedback to fit into a CSI payload.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

NR uses Orthogonal Frequency Division Multiplexing (OFDM) with configurable bandwidths and subcarrier spacing to efficiently support a diverse set of use cases and deployment scenarios. As compared with LTE, NR improves in deployment flexibility, user throughputs, latency and reliability. With NR comes also enhanced support for spatial multiplexing in which time-frequency resources are spatially shared across users, commonly referred to as Multi-User MIMO (MU-MIMO).

An example of MU-MIMO operations is illustrated in FIG. 1, where a multi-antenna network node with N_{TX} antenna ports is spatially transmitting information to several WDs in which sequence SM is aimed for WD denoted as UE(1), and S⁽²⁾ is aimed for wireless device denoted as UE(2), etc. Before modulation and transmission, precoding

$${W}_{V}^{( j )}$$

is applied to each sequence to spatially separate the transmissions, i.e., to mitigate multiplexing interference.

At receiver sides, each WD demodulates its received signal and combines receive antenna signals to obtain an estimate Ŝ⁽ⁱ⁾ of transmitted sequence. This estimate Ŝ⁽ⁱ⁾ can be expressed as

$${\hat{S}}^{( i )} = {\underbrace{{W}_{U}^{( i )} {H}^{( i )} {W}_{V}^{( i )}}}_{\approx I} {S}^{( i )} + {W}_{U}^{( i )} {H}^{( i )} {\sum }_{j , j \neq i} {W}_{V}^{( j )} {S}^{( j )} ,$$

where the second term represents the spatial multiplexing interference seen by UE(i). The goal for the network node is to construct the set of precoders

$$\{ {W}_{V}^{( j )} \}$$

such that the norm

$$‖ {H}^{( i )} {W}_{V}^{( i )} ‖$$

is large whereas the norm

$$‖ {H}^{( j )} {W}_{V}^{( i )} ‖ ,$$

j≠i is small. In other words, the precoder

$${W}_{V}^{( i )}$$

correlates well with the channel H⁽ⁱ⁾ observed by UE(i) whereas it correlates poorly with other channels.

To construct precoders for efficient MU-MIMO transmissions, the network node may need to acquire detailed knowledge of the channels H(i). In deployments where channel reciprocity holds, channel knowledge can be acquired from sounding reference signals (SRS) that are transmitted periodically, or on demand, by active WDs. Based on these SRS, the network node estimates H⁽ⁱ⁾. However, when channel reciprocity does not hold or when SRS coverage is limited, active WDs may need to feedback channel details to the network node. In NR (as well as in LTE), this is done by having the network node periodically transmit Channel State Information Reference Signals (CSI-RS) from which a WD can estimate its channel. The WD then reports CSI, from which the network node can determine suitable precoders for MU-MIMO.

The CSI feedback mechanism targeting MU-MIMO operations in NR is referred to as CSI type II, in which a WD reports CSI feedback with high CSI resolution, as specified, e.g., in 3GPP Technical Specification (TS) 38.214 v17.4.0. It is based on specifying sets of Direct Fourier Transform (DFT) base functions (grid of beams) from which the WD selects those that best match its channel conditions (like classical codebook Pre-coding Matrix Indicator (PMI)). The number of beams the WD reports is configurable via Radio Resource Control (RRC) signaling, and may be 2 or 4, as specified in, e.g., 3GPP Technical Specification (TS) Rel-15 Type II or 2, 4 or 6, as specified, e.g., in TS Rel-16 Type II. In Rel-16 Type II, the CSI report can be further compressed in the frequency domain (FD), where a set of FD DFT basis vectors are selected by the WD. The number of selected FD basis vectors is a function of the number of Channel Quality Indicator (CQI) sub-bands, the number of PMI sub-bands per CQI sub-band and a ratio that determines the FD compression (which may be termed as pᵥ, as specified e.g., in 3GPP TS 38.214, where v is the layer index), which is configured by network node via RRC signaling. In addition, the WD also reports non-zero coefficients (NZCs) associated with the selected beams for Rel-15 Type II, which informs the network node how these beams should be combined in terms of relative amplitude scaling and co-phasing for each sub-band. In Rel-16, the reported NZCs are then associated with selected beams and FD basis vectors. In Rel-16, to further compress the CSI report, network node also configures a ratio, termed as f, to the wireless device via RRC signaling, that determines the maximum number of NZCs to be reported. For example, for a single layer transmission where 2L beams and M FD basis vectors are configured by network node, there are in total 2LM linear combination coefficients. Then, only [2LMβ] NZCs may be reported at most, the remaining 2LM−[2LMβ] are treated as zeros and are not reported. The selected beams are commonly used for all subbands and all transmission layers, whereas the NZCs (for both Rel-15 and Rel-16 Type II) and FD basis vectors (for Rel-16 Type II) are layer-specific.

To further explain the structure of the Type II CSI, an example of the Rel-15 CSI type II is illustrated in FIG. 2 (illustrating a CSI Type II feedback), which illustrates the selection of DFT beam vectors bn (i.e., b₀, b₁, b₂, b₃), and their relative amplitudes aₙ (e.g. a₁, a₂, a₃, a₀=1), are determined from a wideband perspective whereas the co-phasing is per subband. Here, wideband means that the selected DFT beam vectors are the same for all subcarriers used in the OFDM transmission, whereas subband means that co-phasing parameters are determined over subsets of contiguous subcarriers. The co-phasing parameters are quantized such that e^{jθ}^{ₙ} (e.g. e^{jθ}^{₁}, e^{jθ}^{₂}, e^{jθ}^{₃}, e^{jθ}^{₀}=1) is taken from either a QPSK or 8PSK signal constellation.

With k denoting a sub-band index, the precoder reported by the WD can be expressed as

$${W}_{V} [ k ] = {\sum }_{n} {b}_{n} {a}_{n} {e}^{j {θ}_{n} [ k ]} .$$

Note that the reporting overhead for Type II CSI is generally large, especially when comparing to the Type I CSI. A dominant part of the reporting overhead is from sub-band reporting, e.g., the layer-specific NZCs. For instance, it requires about 7 bits (the actual number depends on the release version and parameter configuration) to report the phase and amplitude for one coefficient.

In NR, a WD can be configured with one or multiple CSI Report Settings, each configured by a higher layer parameter CSI-ReportConfig. Each CSI-ReportConfig is associated with a Bandwidth Part (BWP) and may contain one or more of the following:
a CSI resource configuration for channel measurement
a CSI Interference Measurement (CSI-IM) resource configuration for interference measurement
reporting configuration type, i.e., aperiodic CSI (on Physical Uplink Shared Channel (PUSCH)), periodic CSI (on Physical Uplink Control Channel (PUCCH)), or semi-persistent CSI on PUCCH or PUSCH
report quantity specifying what to be reported, such as Rank Indication (RI), PMI, CQI
codebook configuration such as type I or type II CSI
frequency domain configuration, i.e., sub-band vs. wideband CQI or PMI, and sub-band size
CQI table to be used

A WD can be configured with one or multiple CSI resource configurations for channel measurement and one or more CSI-IM resources for interference measurement. Each CSI resource configuration for channel measurement can contain one or more NZP CSI-RS resource sets. For each NZP CSI-RS resource set, it can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

A WD performs aperiodic CSI reporting using PUSCH upon successful decoding of a Downlink Control Information (DCI) format 0_1 or DCI format 0_2, which triggers an aperiodic CSI trigger state.

When a DCI format 0_1 schedules two PUSCH allocations, the aperiodic CSI report is carried on the second scheduled PUSCH. When a DCI format 0_1 schedules more than two PUSCH allocations, the aperiodic CSI report is carried on the penultimate scheduled PUSCH.

A WD performs semi-persistent CSI reporting on the PUSCH upon successful decoding of a DCI format 0_1 or DCI format 0_2 which activates a semi-persistent CSI trigger state. DCI format 0_1 and DCI format 0_2 contains a CSI request field which indicates the semi-persistent CSI trigger state to activate or deactivate. The PUSCH resources and MCS are allocated semi-persistently by an uplink Downlink Control Information (DCI).

CSI reporting on PUSCH can be multiplexed with uplink data on PUSCH. CSI reporting on PUSCH can also be performed without any multiplexing with uplink data from the wireless device.

For the 3GPP Rel-15 Type II and the 3GPP Rel-16 Type II (aka Enhanced Type II, or eType II) CSI feedback on PUSCH, a CSI report includes two parts: Part 1 and Part 2. One reason for dividing a CSI report into Part 1 and Part 2 is to deal with the dynamically varying CSI payload. For example, based on the time-varying channel, a WD may report different ranks over the whole period of connection, which has significant impact on the actual required CSI payload size. In order for the network node to know the actual payload size, Part 1, which has a fixed payload size that carries the information to calculate the payload size of Part 2, will be decoded first by network node.
For the 3GPP Rel-15 Type II CSI feedback, Part 1 contains RI (if reported), CQI, and an indication of the number of non-zero wideband amplitude coefficients per layer for the Type II CSI (see, e.g., Clause 5.2.2.2.3 in 3GPP TS 38.214). The fields of Part 1—RI (if reported), CQI, and the indication of the number of non-zero wideband amplitude coefficients for each layer—are separately encoded. Part 2 contains the PMI of the Type II CSI. Part 1 and 2 are separately encoded.
For the 3GPP Rel-16 Type II CSI feedback, Part 1 contains RI, CQI, and an indication of the overall number of non-zero amplitude coefficients across layers for the 3GPP Rel-16 Type II CSI (see, e.g., Clause 5.2.2.2.5 in 3GPP TS 38.214). The fields of Part 1—RI, CQI, and the indication of the overall number of non-zero amplitude coefficients across layers—are separately encoded. Part 2 contains the PMI of the Enhanced Type II CSI. Part 1 and 2 are separately encoded.

Due to the possibility of a large discrepancy between the PMI payload for different selection of RI by the WD for Type II CSI reporting, it is possible that the PUSCH resource allocation for carrying the CSI report does not fit the entire CSI content. For instance, the rank-2 PMI payload is almost 2× the rank-1 PMI payload for the 3GPP Rel-15/Rel-16 Type II codebook. And since the RI is dynamically selected by the WD, the network node may be unable to predict the PMI payload before scheduling the CSI report and hence the resource allocation may be too small. That is, the network node may have scheduled a resource appropriate for a rank-1 PMI report (due to, e.g., the wireless device recently reporting RI=1), but the WD reports rank-2 PMI, which may not fit in the allocated PUSCH resource.

To address this, CSI omission procedures have been specified in 3GPP, where a portion of CSI Part 2 can be omitted if the resulting Uplink Control Information (UCI) code rate is too low (Part 1 may not be able to be omitted, as it may be needed to correctly decode Part 2). This is achieved by segmenting the CSI Part 2 payload into different priority levels, and dropping the CSI segment starting with the lowest priority level until the UCI code rate falls below a threshold (whereby the CSI payload will “fit” on the PUSCH allocation). The priority levels for both 3GPP Rel-15 and 3GPP Rel-16 Type II are described, e.g., in Table 1 (reproduced from 3GPP Technical Specification (TS) 38.214 Table 5.2.3-1), where Priority 0 has the highest priority and N_{Rep} represents the number of CSI reports. The CSI omission procedure is explained in more detail below.

TABLE 1
Priority reporting levels for Part 2 CSI
Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report
N_{Rep}, if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

For 3GPP Rel-15 Type II, CSI Part 2 is divided into a wideband PMI part and a subband PMI part. The wideband part carries information such as spatial domain (SD) basis indication including rotation factor (for regular Type II) or port indication (for port-selection Type II), wideband amplitude coefficients per layer and strongest coefficient indicator (SCI) per layer. The subband part carries information such as subband amplitude and phase.

The subband PMI may be the most payload heavy since it is reported independently for each subband (whereas the wideband PMI is only reported once for the entire CSI reporting band). In the described CSI omission procedure, subband PMI for odd and even numbered subbands are respectively grouped into different CSI segments with different priority. This implies that if the PUSCH resource allocation is too small to fit the CSI payload, the subband PMI for the odd subbands can be dropped and only subband PMI for even subbands are reported.

A motivation behind this design is that the reported remaining PMI can still be used by the network node. Since the network node has knowledge of the subband PMI for every other subband, it can perform interpolation between subbands to estimate the PMI for the omitted subbands. Due to the subband PMIs being correlated in frequency, the performance loss may not be that severe.

For 3GPP Rel-16 Type II, CSI Part 2 is segmented into three groups:

Group 0: SD basis indication including rotation factor (for Rel-16 regular Type II) or port indication (for Rel-16 port-selection Type II), SCI for each layer.

Group 1: FD basis indication for each layer, wideband (polarization) reference amplitude, part of the bitmap and amplitude and phase for subband coefficients with the highest priority.

Group 2: the remaining part of bitmap and amplitude and phase for subband coefficients with the lowest priority.

For each reported element of bitmap, subband amplitude and phase in Group 1 and 2, a priority level is determined via the value of the following priority function, indexed by l, i, f:

$$Pri ( l , i , f ) = 2 \cdot L \cdot v \cdot π ( f ) + v \cdot i + l ,$$

$$with π ( f ) = min ( 2 \cdot {n}_{3 , l}^{( f )} , 2 \cdot ( {N}_{3} - {n}_{3 , l}^{( f )} ) - 1 ) with l = 1 , 2 , … , v$$

being the layer index and v being the RI, i=0, 1, . . . , 2L−1 being the index of selected ports, f=0, 1, . . . , Mᵥ−1 being the index of selected FD basis vectors and Mᵥ being the number of selected FD basis vectors for each layer, and

$${n}_{3 , l}^{( f )} ∈ \{ 0 , 1 , … , {N}_{3} - 1 \}$$

being the index of FD basis vectors from which the WD can select, and N₃ is the number of PMI subbands. The element with the highest priority has the lowest associated value Pri(l,i,f).

A motivation behind the way grouping is done is that network node may still be able to recover part of the CSI even if some low priority groups are omitted. For example, if Group 1 and 2 are omitted, the PMI feedback in Group 0 is essentially a Type I PMI, network node can still schedule SU-MIMO based on that CSI report. In another example, if Group 2 is omitted, information of selected SD and FD basis vectors is still complete, it may only be part of the combination coefficients that is omitted. However, since the combination coefficients are reported and omitted in a predictable manner based on the pre-defined priority function, network node is still aware of the association between the reported coefficients and the SD and FD basis vector. Thus, DL channel can still be partly obtained via the incomplete CSI report.

Recently neural network (NN) based autoencoders (AEs) have been used for compressing downlink MIMO channel estimates for uplink feedback.

Furthermore, 3GPP decided to start a study item for Rel.18 that includes the use case of AI-based CSI reporting, in which AEs are part of the study. Specifically, an AE is a type of artificial neural network that can be used to compress and decompress data, in an unsupervised manner, often with high fidelity.

FIG. 3 illustrates an example of a low complexity fully connected (dense) AE. The AE is divided into two parts:
an encoder (used to compress the input data X), and
a decoder (used to de-compress the input data).

AEs can have different architectures. For example, AEs can be based on dense NNs, multi-dimensional convolution NNs, variational, recurrent NNs, transformer networks, or any combination thereof.

However, all AE architectures possess an encoder-bottleneck-decoder structure as illustrated in FIG. 3. In FIG. 3, the size of the codeword (denoted by Y in FIG. 3) of an AE is typically a lot smaller than the size of the input data (X in FIG. 3). The AE encoder thus reduces the dimensionality of the input features X (here illustrated with 8 features) down to Y (here illustrated with 2 features). The decoder part of the AE tries to invert the encoder and reconstruct X (i.e., back to 8 features) with minimal error, according to some predefined loss function.

FIG. 4 illustrates an example of how an AE might be used for AI/machine learning (ML)-enhanced CSI reporting in NR. The WD measures the channel in the downlink using CSI-RS. The WD estimates that channel for each subcarrier (SC) from each network node transmission (TX) antenna and at each wireless device receiving (RX) antenna. The estimate can be viewed as a three-dimensional (3D) channel matrix. The 3D channel matrix represents the MIMO channel estimated over several SCs and is input to the encoder.

The AE encoder is implemented in the WD, and the AE decoder is implemented in the network, e.g., in a network node. The output of the AE encoder is signaled from the WD to the network node over the uplink. The codeword can be viewed a learned latent representation of the channel. The architecture of an AE (e.g., number of layers, nodes per layer, activation function) typically needs to be numerically optimized for CSI reporting via a process called hyperparameter tuning. Properties of the data (e.g., CSI-RS channel estimates), the channel size, uplink feedback rate, and hardware limitations of the encoder and decoder may all need to be considered when optimizing the AE's architecture.

The weights and biases of an AE (with a fixed architecture) are trained to minimize the reconstruction error (the error between the input X and output X) on some training dataset. For example, the weights and biases can be trained to minimize the mean squared error (MSE) (X−\hat{X})². Model training is typically done using some variant of the gradient descent algorithm on a large training data set. To achieve good performance during live operation, the training data set should be representative of the actual data the AE will encounter during live operation.

In the two-sided CSI compression, the output of the WD-side encoder needs to be communicated over the air interface to the network node decoder with the assigned CSI reporting payload and, therefore, needs to be quantized to a finite number of bits (e.g., 1-4 bits per sample for the UCI) to obtain an efficient transmission, as shown in the example of FIG. 5 (illustrating quantization operation at the output of the encoder to fit the CSI payload over the air interface). Accordingly, a quantization layer is usually connected at the output of the encoder or directly included in the encoder. In an example, the quantization layer may implement scalar quantization which quantizes the output of each neuron of the encoder output layer (the bottleneck layer of AE) to generate bits to fit the CSI reporting payload in the UCI. Other quantization methods, e.g., vector quantization, may also be used.

A proper pre-processing on the input to the encoder can greatly reduce the size and complexity for designing and/or training an AI/ML model, and in the meantime, improving the scalability and transferability of the model. In the CSI compression, a pre-processing method could be a transformation of the channel from antenna-frequency domain to beam-delay domain, or from the antenna-frequency-time domain to the beam-delay-doppler domain. In addition, the pre-processing is used to reduce the need for multiple models depending on bandwidth variation and variation in the number of antenna ports at the network node.

To further explain this, the channel representation in the antenna-frequency domain is usually rich and hard to compress, however, its equivalent form in the beam-delay domain is sparse and easier to compress. Such sparsity, to some extent, reflects the physical interpretation of a propagation channel. That is, it reflects how the numerous sinusoidal signals traverse from the transmitting end, along different paths, to the receiving end. Essentially, each beam can be associated with a certain direction of a propagation path, and each delay can reflect the relative difference in distance if a signal propagates along different paths. Each pair of beam and delay may be associated with a single propagation path, if there is infinite spatial resolution and delay resolution.

In real propagation environment, dominant paths that contribute to conveying a signal are usually sparse if looking at the whole 3D space, since the signal cannot reach to the receiver end from any direction. Among other reasons, this is limited by the antenna directivity and the number of antenna elements deployed at both the transmitter and the receiver, as well as the number of objects in the propagation environment that can reflect a signal without introducing significant loss. The above sparsity can be exploited to assist an AI/ML model. For example, the beam-delay domain transformation could help the AI/ML model with an initial feature extraction. Another advantage of this pre-processing is that the beam-delay transformation can be achieved using Fast Fourier Transforms (FFTs), for which there are already fast implementations with hardware support. The sparsity can be further exploited by removing a number of insignificant beams and delays, so that the input dimensions could also be reduced with a marginal loss, likely resulting in smaller AI/ML models. The beam-delay transformation and feature extraction can be applied both cases of explicit channel feedback and eigenvector-based feedback.

A brief example in described next for pre-processing of the eigenvector-based feedback, which has received immediate attention in 3GPP. The first step is that the WD measures the channel on CSI-RS. For example, let the WD have 4 Rx-ports, the configured CSI-format has 32 virtual Tx-ports, and the bandwidth are 52 Resource Blocks (RBs) corresponding to 10 MHz at 15 kHz subcarrier spacing. An example of feature extraction for eigenvector-based feedback is illustrated in FIG. 6. The steps are as follows:
1. The WD does a spatial domain DFT on the 32×4 matrix per RB and selects the L strongest beams out of 16 (for one polarization) (Block S10). This is done in a wideband manner, including the spatial oversampling of the SD basis, and the same beams are used for both polarizations. The covariance of the beam-space channel is summed over, e.g., 4 RBs to produce a covariance matrix for each sub-band.
2. For each covariance matrix (per sub-band) the device extracts a number of eigenvectors and may select the rank, i.e., number of layers (Block S12).
3. The device performs a frequency domain DFT per layer, transforming to delay domain, whereafter it selects the M strongest taps (Block S12). The resulting tensor of dimensions 2L×number of layers×M is called the linear combination coefficients and can be used to reconstruct, by the WD suggested, precoding matrices.
4. The tensor of linear combination coefficients is used as input in the AI/ML model (Block S14). The input could be further enhanced with information about the selected beams and taps, noise levels, etc.
   AE models implicit CSI feedback for RI>1

There can be several schemes for AI/ML models for implicit CSI feedback when RI>1, i.e., the indicated rank is greater than one. There may be two main categorizations of the AI/ML models when RI>1, as follows:
1. Transmission layer common scheme: This scheme includes one AI/ML model, which is trained and deployed for all the transmission layers based on the estimated RI, as illustrated in the example FIG. 7, where H and H_{I} are the estimated transmission channel and interference channel, respectively.
2. Transmission layer specific scheme: This scheme includes multiple AI/ML models, which are trained and deployed for each of the transmission layers based on the estimated RI as illustrated in the example of FIG. 8, where H and H_{I} are the estimated transmission channel and interference channel, respectively.

Note that in the above examples, a model is trained for a transmission layer irrespective of the RI. Additionally, the model for a transmission layer can further depend on RI. However, the CSI report mechanism in the UCI may apply to both the cases where the model is either independent or dependent on RI.

### SUMMARY

Some embodiments advantageously provide methods, systems, and apparatuses for modifying Artificial intelligence (AI)-based Channel State Information (CSI) feedback to fit into a CSI payload.

AI-based CSI report will be studied and specified in 3^{rd} Generation Partnership Project (3GPP) Release (Rel)-18. The bits for AI-based CSI feedback can be large enough to fit into the CSI payload pre-determined by the network node. Like the legacy CSI reporting, there is a need to define omission rules for AI-based CSI report to eliminate low priority bits to fit into the CSI payload.

Described herein are, approaches for the omission rules to eliminate low priority bits to fit the AI-based CSI feedback bits into the CSI payload on Uplink Control Information (UCI). Accordingly, the proposed AI-based CSI report is robust to a dynamically varying channel and/or payload size.

According to a first aspect, a method implemented by a wireless device (WD) is provided. The method comprises receiving, from a network node, a configuration for a CSI payload size. The method comprises transmitting, to the network node, a CSI report. The CSI report has been generated by omitting a plurality of bits according to an omission rule such that the CSI report has a size less than or equal to the CSI payload size.

According to a second aspect, a WD configured to communicate with a network node is provided. The WD is configured to receive, from the network node, a configuration for a CSI payload size. The WD is configured to transmit, to the network node, the CSI report. The CSI report has been generated by omitting a plurality of bits according to an omission rule such that the CSI report has a size less than or equal to the CSI payload size.

According to a third aspect, a method implemented by a network node is provided. The method comprises configuring a WD with a CSI payload size. The method comprises receiving, from the WD, a CSI report. The CSI report being generated by omitting a plurality of bits according to an omission rule such that the CSI report has a size less than or equal to the CSI payload size. The WD is configured to perform at least one action based on the received CSI report.

According to a fourth aspect, a network node configured to communicate with a WD is provided. The network node is configured to configure the WD with a CSI payload size. The network node is configured to receive, from the WD, a CSI report. The CSI report being generated by omitting a plurality of bits according to an omission rule such that the CSI report has a size less than or equal to the CSI payload size. The network node is configured to perform at least one action based on the received CSI report.

According to a fifth aspect, a computer program comprising instructions which, when executed on at least one processing circuitry of a WD, causes the WD to carry out the method according to the first aspect.

According to a sixth aspect, a computer program comprising instructions which, when executed on at least one processing circuitry of a network node, causes the network node to carry out the method according to the third aspect.

According to a seventh aspect, a computer program product comprising instructions which, when executed on at least one processing circuitry of a WD, causes the WD to carry out the method according to the first aspect.

According to an eighth aspect, a computer program product comprising instructions which, when executed on at least one processing circuitry of a network node, causes the network node to carry out the method according to the third aspect.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1: is a flowchart illustrating a multiple Multi User-Multiple Input, Multiple Output (MU-MIMO) operation;

FIG. 2: is an illustration of CSI Type II feedback;

FIG. 3: is an illustration of a fully connected autoencoder;

FIG. 4: is an illustration of use of an autoencoder for CSI compression;

FIG. 5: is flowchart of a quantization operation at the output of the encoder to fit the CSI payload over the air interface;

FIG. 6: is an illustration of pre-processing for implicit feedback of the eigenvector based on an estimated transmission rank;

FIG. 7: is an illustration of a transmission layer common model;

FIG. 8: is an illustration of a transmission layer specific model;

FIG. 9 is a schematic diagram of an example network architecture illustrating a communication system connected via an intermediate network to a host computer according to the principles in the present disclosure;

FIG. 10 is a block diagram of a host computer communicating via a network node with a wireless device over an at least partially wireless connection according to some embodiments of the present disclosure;

FIG. 11 is a flowchart illustrating example methods implemented in a communication system including a host computer, a network node and a wireless device for executing a client application at a wireless device according to some embodiments of the present disclosure;

FIG. 12 is a flowchart illustrating example methods implemented in a communication system including a host computer, a network node and a wireless device for receiving user data at a wireless device according to some embodiments of the present disclosure;

FIG. 13 is a flowchart illustrating example methods implemented in a communication system including a host computer, a network node and a wireless device for receiving user data from the wireless device at a host computer according to some embodiments of the present disclosure;

FIG. 14 is a flowchart illustrating example methods implemented in a communication system including a host computer, a network node and a wireless device for receiving user data at a host computer according to some embodiments of the present disclosure;

FIG. 15 is a flowchart of an example process in a network node according to some embodiments of the present disclosure;

FIG. 16 is a flowchart of an example process in a wireless device according to some embodiments of the present disclosure;

FIG. 17: is a schematic diagram of an example architecture for a channel eigenvector feedback approach according to some embodiments of the present disclosure;

FIG. 18 is a diagram of a transmission layer common model according to some embodiments of the present disclosure;

FIG. 19 is a diagram of a transmission layer-specific model according to some embodiments of the present disclosure;

FIG. 20 is a diagram of a transmission layer common model according to some embodiments of the present disclosure; and

FIG. 21 is a transmission model for explicit CSI feedback according to some embodiments of the present disclosure.

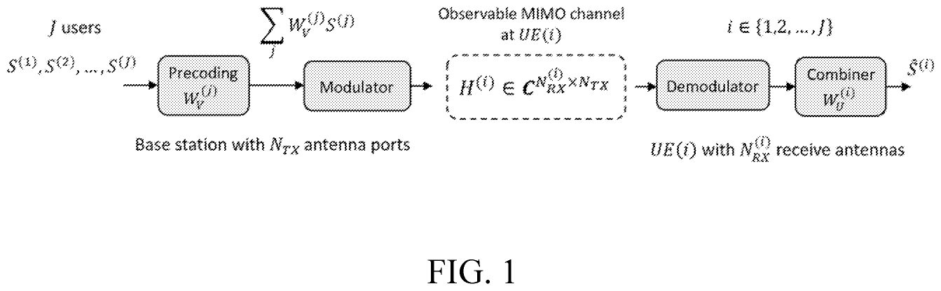

### DETAILED DESCRIPTION

Before describing in detail exemplary embodiments, it is noted that the embodiments reside primarily in combinations of apparatus components and processing steps related to modifying artificial intelligence (AI)-based channel state information (CSI) feedback to fit into a CSI payload. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, g Node B (gNB), Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B, or one or both of A and B. In some embodiments, at least one of A, B and C corresponds to one or more of A, B and C, and/or A, B, C, or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for modifying AI-based CSI feedback to fit into a CSI payload.

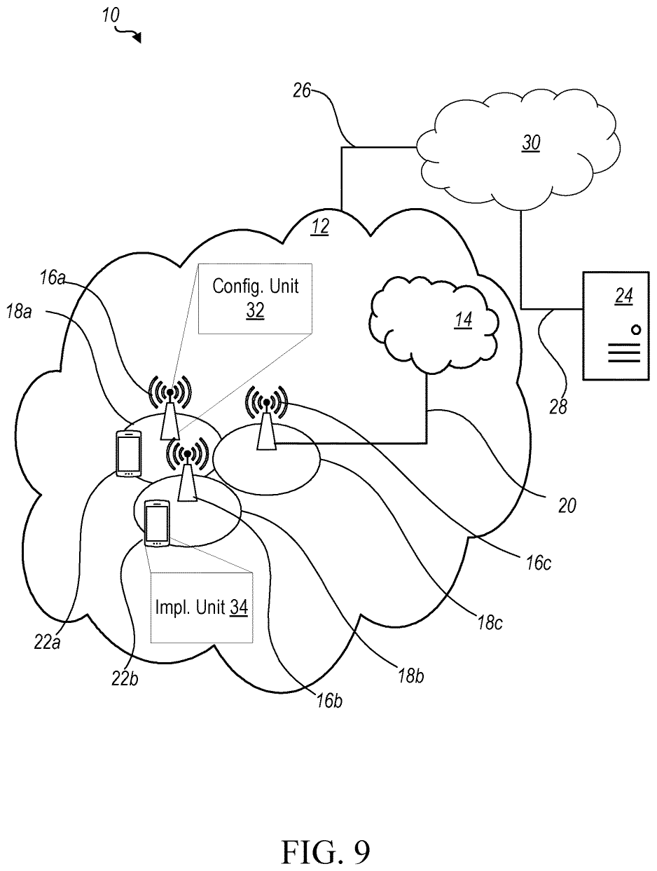

Referring again to the drawing figures, in which like elements are referred to by like reference numerals, there is shown in FIG. 9 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first WD 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 9 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions described herein, including functions related to modifying AI-based CSI feedback to fit into a CSI payload. A wireless device 22 is configured to include an implementation unit 34 which is configured to perform one or more WD 22 functions described herein, including functions related to modifying AI-based CSI feedback to fit into a CSI payload.

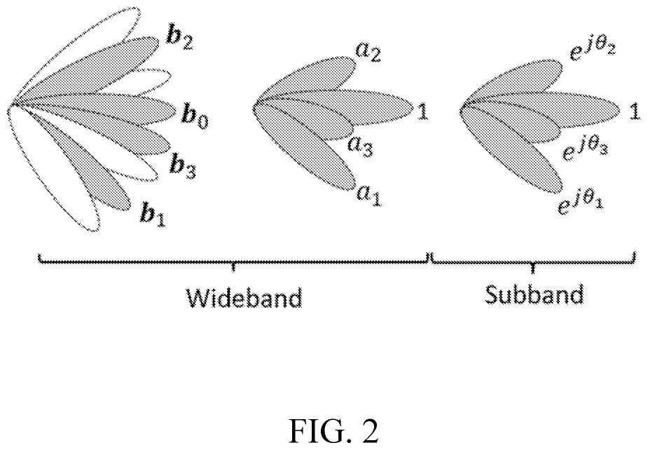

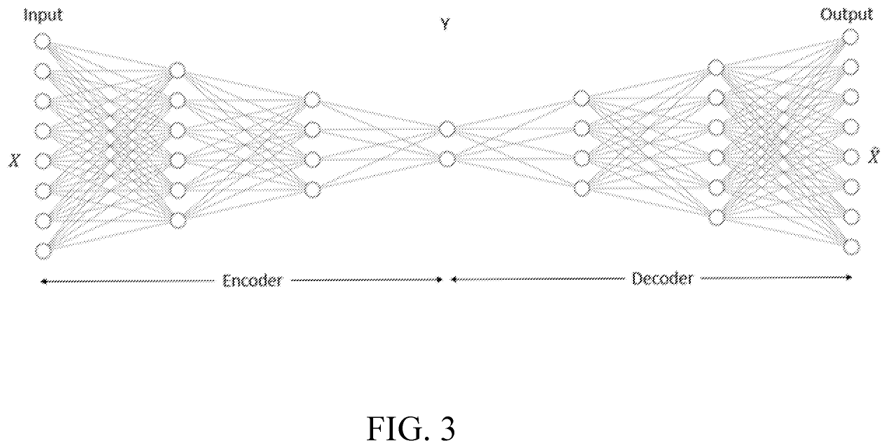

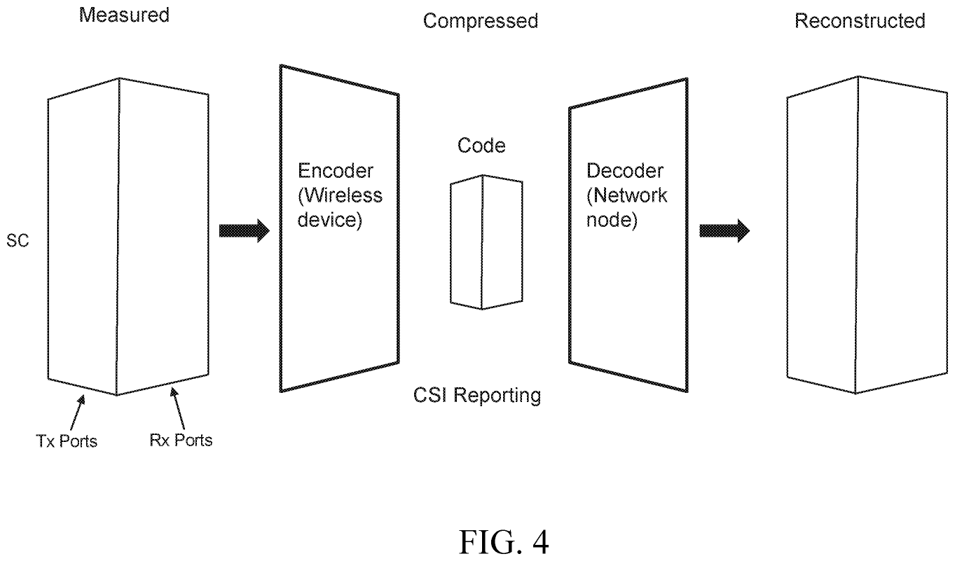

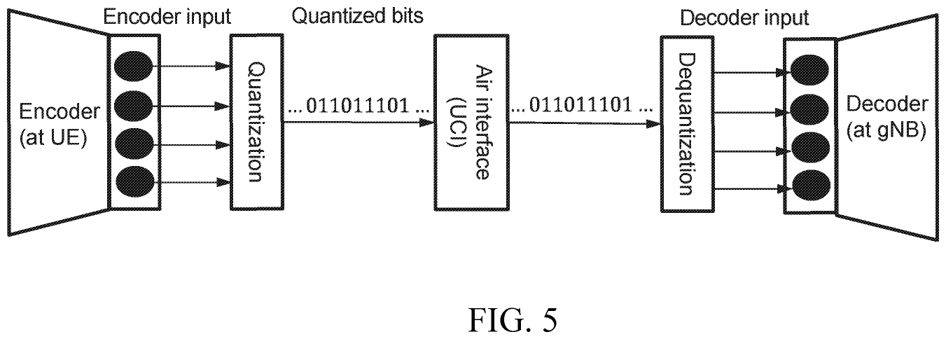

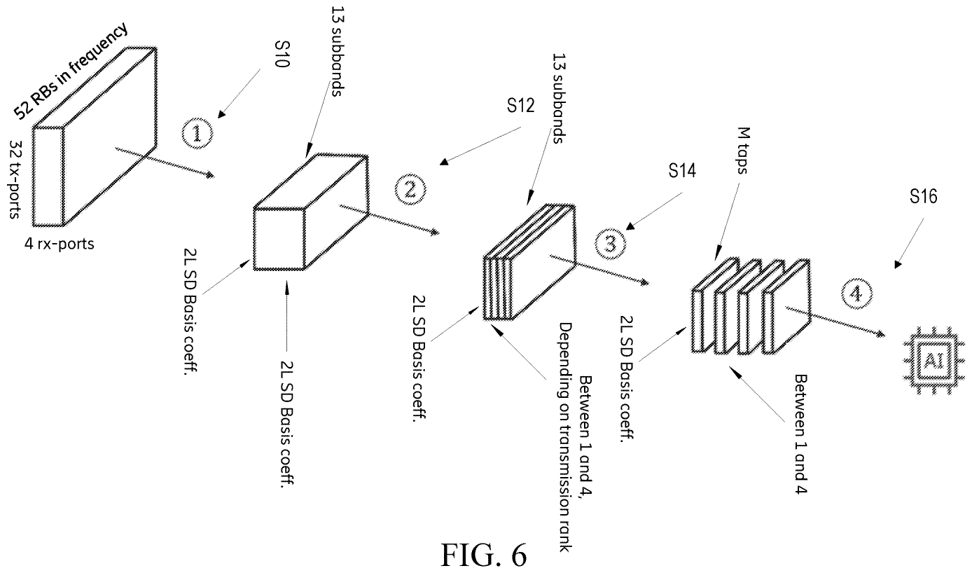

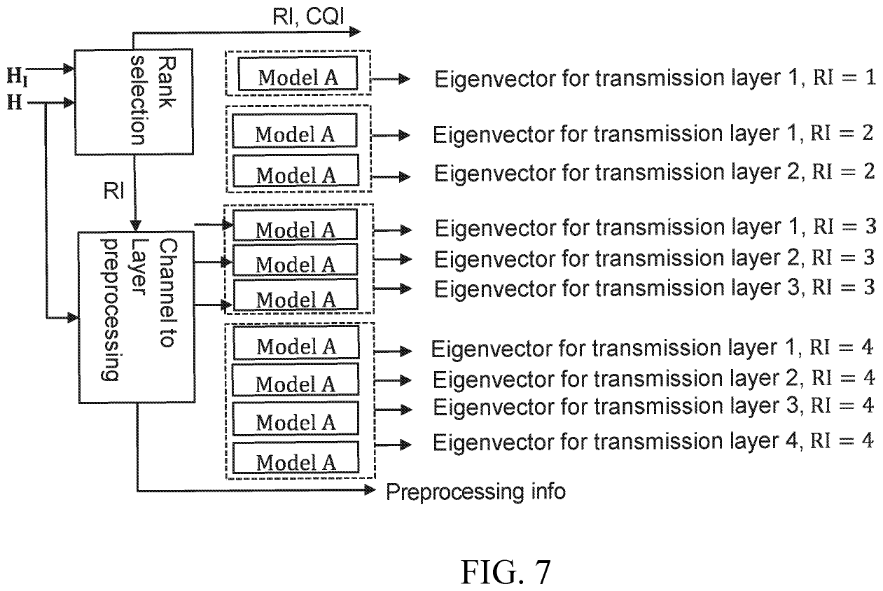

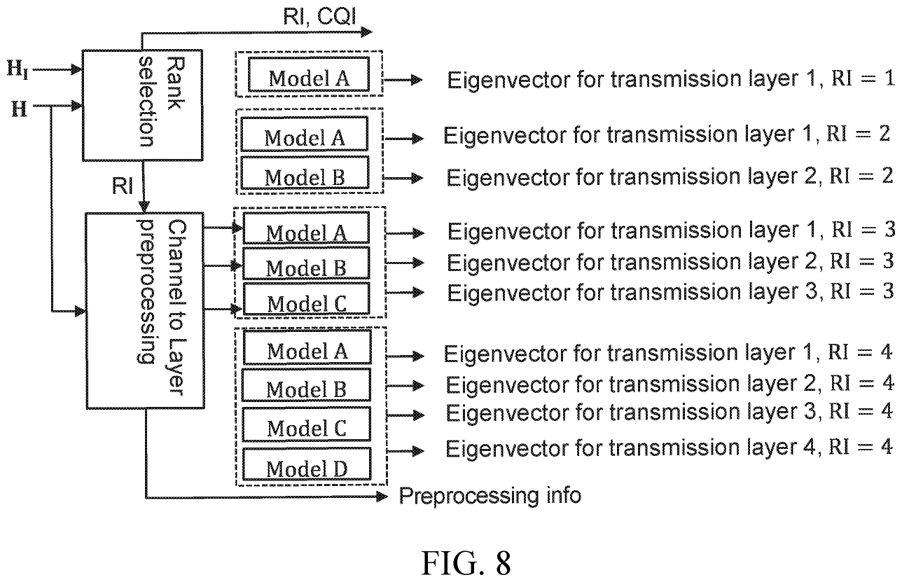

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a control unit 54 configured to enable the service provider to observe/monitor/control/transmit to/receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions described herein, including functions related to modifying AI-based CSI feedback to fit into a CSI payload.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include implementation unit 34 configured to perform one or more wireless device 22 functions described herein, including functions related to modifying AI-based CSI feedback to fit into a CSI payload.

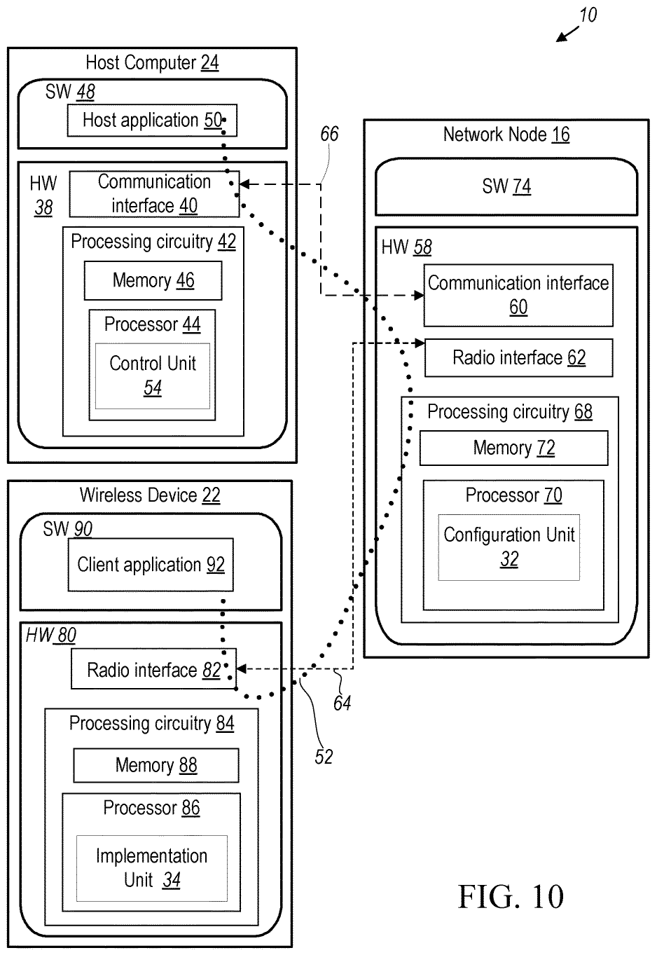

In some embodiments, the inner workings of the network node 16, WD 22, and host computer 24 may be as shown in FIG. 10 and independently, the surrounding network topology may be that of FIG. 9.

In FIG. 10, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 9 and 10 show various “units” such as configuration unit 32, and implementation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

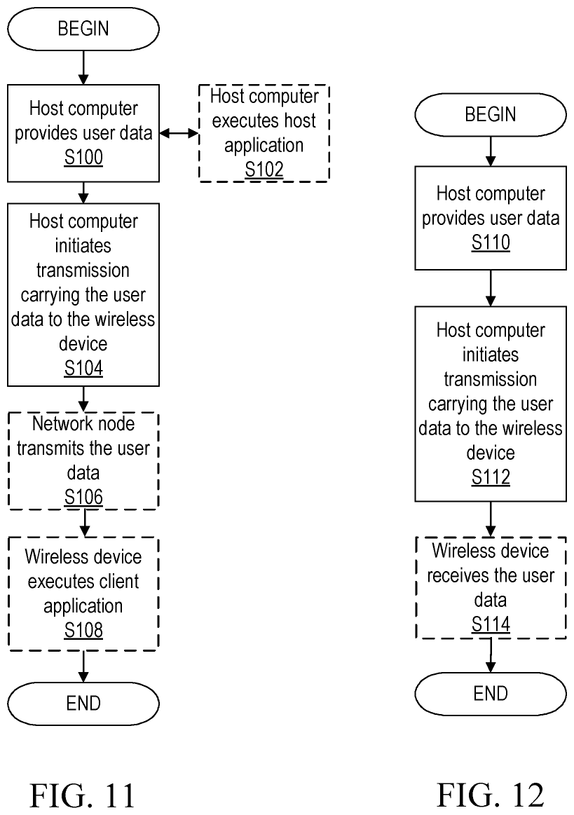

FIG. 11 is a flowchart illustrating an exemplary method implemented in a communication system, such as, for example, the communication system of FIGS. 9 and 10, in accordance with one embodiment. The communication system may include a host computer 24, a network node 16 and a WD 22, which may be those described with reference to FIG. 10. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 12 is a flowchart illustrating an exemplary method implemented in a communication system, such as, for example, the communication system of FIG. 9, in accordance with one embodiment. The communication system may include a host computer 24, a network node 16 and a WD 22, which may be those described with reference to FIGS. 9 and 10. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

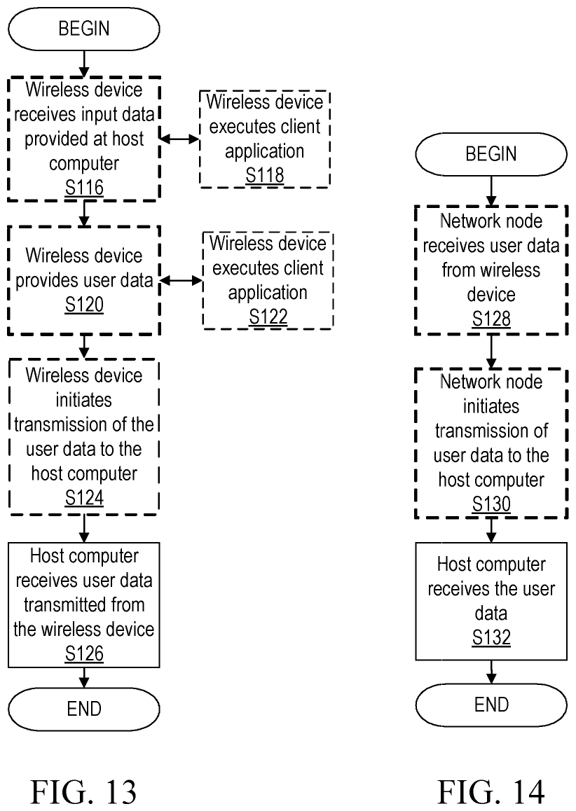

FIG. 13 is a flowchart illustrating an exemplary method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 14 is a flowchart illustrating an exemplary method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

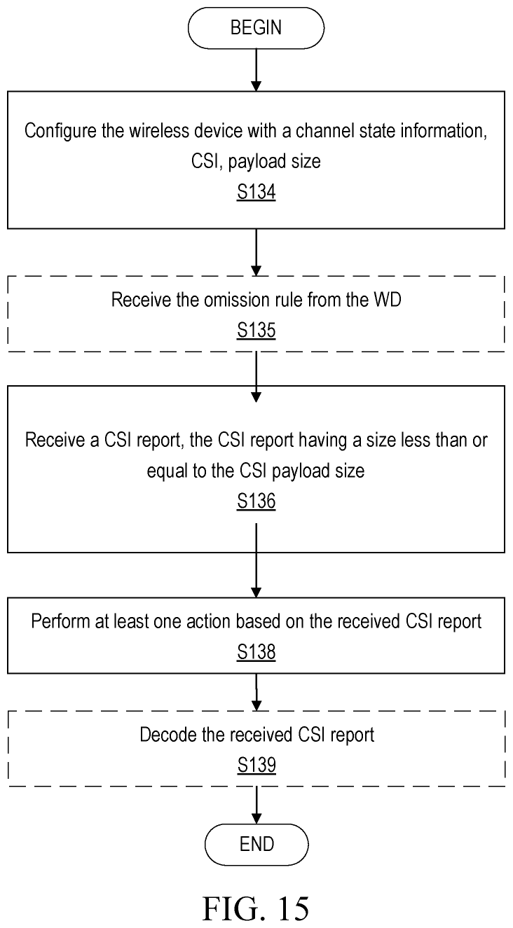

FIG. 15 is a flowchart of an exemplary process in a network node 16. One or more blocks described herein may be performed by one or more elements of network node 16 such as by one or more of processing circuitry 68 (including the configuration unit 32), processor 70, radio interface 62 and/or communication interface 60. In block S134, the network node 16 is configured to configure the WD 22 with a CSI payload size. In block S135, the network node 16 may be configured to receive an omission rule from the WD 22. In block S136, the network node 16 is configured to receive a CSI report from the WD, wherein the CSI report has a size less than or equal to the CSI payload size. In block S138, the network node 16 is configured to perform at least one action based on the received CSI report. In block S139, the network node 16 may be configured to decode the received CSI report.

In at least one embodiment, the received CSI report is an AI-based CSI report. In at least one embodiment, the received CSI report may be generated, by the WD, by omitting a plurality of bits according to an omission rule configured by the WD. In at least one embodiment, the omission rule is configured by the WD 22 and includes at least one of: a number of active latent-space coefficients at an output of an AI model used to generate the CSI report; and a number of quantization bits for each of a plurality of latent-space coefficients corresponding to uplink control information (UCI).

In at least one embodiment, the omission rule corresponds to a pre-defined priority function, the pre-defined priority function being based on one or more of: a transmission rank; a transmission layer; a number of latent-space coefficients per transmission layer at an output of an AI model used to generate the CSI report; an index of each latent-space coefficient per transmission layer at the output of the AI model at the wireless device; and a segmentation of bits within CSI Part 2.

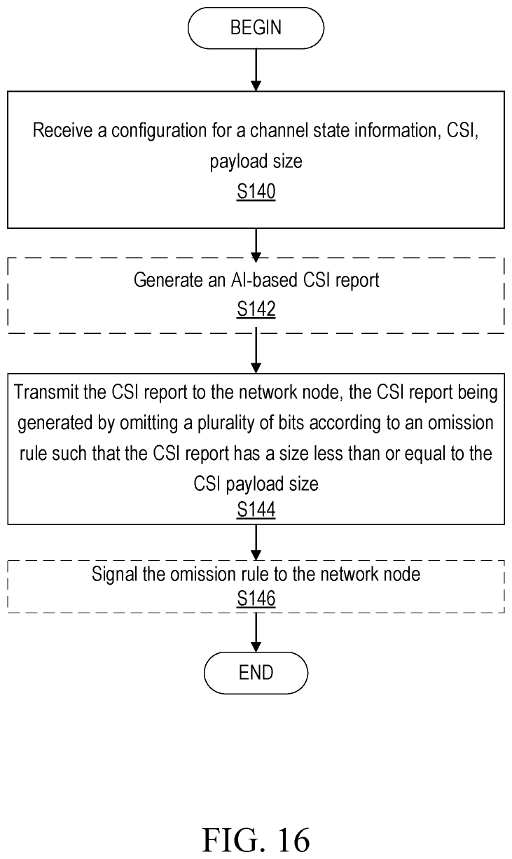

FIG. 16 is a flowchart of an exemplary process in a WD 22. One or more blocks described herein may be performed by one or more elements of the WD 22 such as by one or more of processing circuitry 84 (including the implementation unit 34), processor 86, radio interface 82 and/or communication interface 60. In block S140, the WD 22 is configured to receive a configuration for a CSI payload size. In block S142, the WD 22 may be configured to generate an AI-based CSI report. In block S144, the WD 22 is configured to transmit a CSI report to the network node 16, wherein the CSI report has been generated by omitting a plurality of bits according to an omission rule such that the CSI report has a size less than or equal to the CSI payload size. In block S146, the WD 22 may be configured to signal the omission rule to the network node 16.

In at least one embodiment, the omission rule is configured by the WD 22 and includes at least one of: a number of active latent-space coefficients at an output of an AI model used to generate the CSI report; and a number of quantization bits for each of a plurality of latent-space coefficients corresponding to UCI.

In at least one embodiment, the omission rule corresponds to a pre-defined priority function, the pre-defined priority function being based on one or more of: a transmission rank; a transmission layer; a number of latent-space coefficients per transmission layer at an output of an AI model used to generate the CSI report; an index of each latent-space coefficient per transmission layer at the output of the AI model at the wireless device; and a segmentation of bits within CSI Part 2.

Having described the general process flow of arrangements of the disclosure and having provided examples of hardware and software arrangements for implementing the processes and functions of the disclosure, the sections below provide details and examples of arrangements for modifying AI-based CSI feedback to fit into a CSI payload. One or more WD 22 functions described below may be performed by one or more of processing circuitry 84, processor 86, implementation unit 34, etc. One or more network node 16 functions described below may be performed by one or more of processing circuitry 68, processor 70, configuration unit 32, etc.

In at least one embodiment, the wireless device 22 estimates the DL channel based on the configured DL reference signals (e.g., CSI-RS, Demodulation Reference Signal (DMRS)), and produces a channel estimate H, for example, in the antenna-frequency domain. The raw channel H can be expressed per CSI-RS port (TX side), per receive antenna (RX side), per frequency sub-band, and measured at one or more points in time. Hence, in the most general cases, the channel H is a four-dimensional matrix or tensor.

The raw channel estimate H (possibly together with interference channel) is leveraged to estimate the appropriate rank for the downlink transmission and further processed to extract the eigenvector corresponding to each layer according to the estimated rank r. The eigenvectors per transmission layer based on r is denoted by e_{r,l}_{ᵣ}, where lᵣ=1, 2, . . . , r. For measurements with CSI-RS at a single time instance, e_{r,l}_{ᵣ} is a tensor with dimension equal to number of CSI-RS ports x number of layers×number of frequency subbands. The extracted e_{r,l}_{ᵣ} are compressed and quantized at the encoder into bits, such that bₗ_{ᵣ} represents the bits for quantizing the lᵣ-th transmission layer. Subsequently, the concatenated bits across all the transmission layers, denoted by b_{AE}=[b₁, b₂, . . . , bₗ_{ᵣ}], along with the rank indication (RI) and channel quality indicator (CQI), is reported back to the network node 16 as part of the uplink CSI report. The CSI report comprising of b_{AE} and the legacy parameters computed from the estimated channel H, i.e., RI and CQI, are fed to the decoder deployed at the network node 16 to reconstruct the eigenvectors per layer, denoted by ê_{r,l}_{ᵣ}, lᵣ=1, 2, . . . , r. The network node 16 can further process the eigenvectors to obtain the precoders for each layer, denoted by p_{r,l}_{ᵣ}, lᵣ=1, 2, . . . , r for the transmission of the PDSCH.

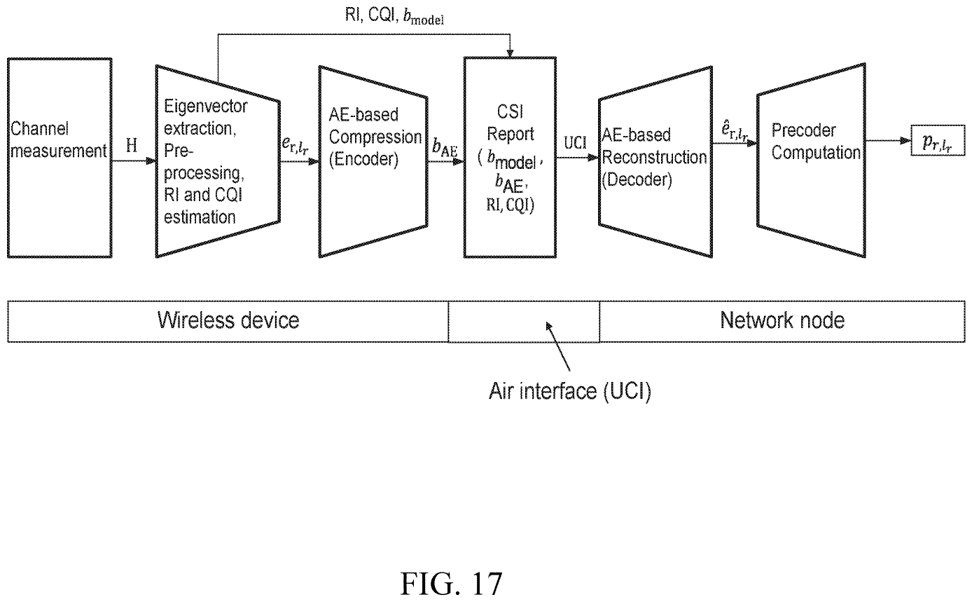

The dimension of raw e_{r,l}_{ᵣ} can be very large depending on the number of CSI-RS ports and the number of subbands, which can make the autoencoder (AE) model and training complex. Accordingly, H may be further pre-processed to have reduced dimension compared to the raw eigenvectors per layer based on feature extraction of the eigenvectors. As described herein, the pre-processing of the channel to extract features of eigenvectors per layer in the beam-delay domain with L Spatial Domain (SD) basis and M delay-taps (through M Frequency Domain (FD) basis), results in a linear combination coefficient tensor of dimensions 2L× number of layers×M, denoted by W₂. In a more specific implementation, values for L and M can be chosen from 3GPP Rel-16 Type-II pre-processing, as specified, e.g., in 3GPP TS 38.214 (M depends on the value of pᵥ in, e.g., 3GPP TS 38.214, where v is the layer index). With the above pre-processing, the encoder at the WD 22 compresses and quantizes W₂, where the reduced dimension of W₂ can lead to reduced AE model size and lower training complexity. As described herein, the feedback of NZCs of W₂ contributes to major overhead for Type-II, which can be reduced leveraging feedback through an AE. The above pre-processing for eigenvectors may require the WD 22 to explicitly feedback L SD and M FD basis back to the network node 16 as part of the uplink CSI report in the UCI. Accordingly, the indices of the L SD and M FD basis are encoded into bits, denoted as b_{model}, and reported to the network node 16, as part of the uplink CSI report. Based on the above, the processing of the channel to produce the CSI report in the UCI to generate the precoders for each transmitted layer through the AE is shown in FIG. 17, which depicts an example architecture of the channel eigenvector feedback approach for the CSI report in the UCI to generate the precoders for each transmitted layer at the network node 16. The per-layer input of the encoder is called eigenvectors. However, the term eigenvector may also be used in a wide sense that incorporates different ways for the WD 22 to extract precoding information for different layers.

Based on the above, a detailed reporting mechanisms (what quantities to report and how to report them) for the AI-based implicit CSI feedback based on the eigenvector decomposition of the estimated CSI per transmission layer based on RI is described. The CSI reporting methodology for the AI-based CSI feedback is discussed for transmission layer-common, transmission layer-specific, and explicit AI-based CSI reporting. Following the legacy structure, the CSI report is segmented into Part 1 CSI and Part 2 CSI, where Part 2 CSI is further divided into sub-segments. The CSI reports carried on Part 1 and Part 2 are part of the UCI, which can either be carried on Physical Uplink Control Channel (PUCCH) or Physical Uplink Shared Channel (PUSCH) (as specified, e.g., in 3GPP TS 38.214).

The common report quantities for the AI-based CSI and the legacy CSI (e.g., Type I/II), such as CSI-RS resource indicator (CRI), rank indicator (RI) and CQI may be reported in Part 1 CSI (as specified, e.g., in 3GPP TS 38.214). The total bits at the wireless device 22 corresponding to the transmission layers, i.e., b_{AE}, are reported in Part 2 CSI. As discussed herein, the pre-processing can be carried out to extract the features of eigenvectors per transmission layer in the beam-delay domain with L SD basis and M FD basis, which are feedback back with b_{model} bits, where the size of b_{model} can be carried on Part 1 CSI, and the b_{model} bits can be carried on Part 2 CSI of the UCI. Further, the bits, denoted by b_{AUX}, providing auxiliary information to the network node 16 to estimate the payload of the received CSI report and decode the transmission layer information can included in CSI Part 1 or CSI Part 2 or both.

However, there can be a large discrepancy between the CSI payload assigned by the network node 16 for different selection of RI by the WD 22 for AI-based CSI reporting, which results in PUSCH resource allocation for carrying the CSI report not fitting the entire CSI content. To solve the problem, like in the legacy NR, CSI omission procedures for AI-based CSI reporting are described. The omission rules are based on the segmentation of CSI part 2.

A network node 16 may be configured to perform at least some machine learning (ML) operations or may support device-to-device (D2D) communication.

With CSI reporting for AI based CSI compression, it is possible to reduce and/or drop part of the CSI when the allocated UCI size is not sufficient to carry the complete CSI report.
In at least one embodiment, where the WD 22 can explicitly signal the number of active latent-space coefficients at the AI model at the output of the wireless device 22 per transmission layer and/or the number of quantization bits used per latent-space coefficient, the WD 22 can reduce one or both of these parameters to bring the CSI report within the UCI allocation. Subsequently, the WD 22 can signal the network node 16 the above parameters to use while decoding the CSI report.
In at least one embodiment, the above procedure can be adopted when explicit CSI is reported to the network node 16 by the WD 22.

However, when the WD 22 has to adhere to the number of active latent-space coefficients at the AI model per transmission layer and/or the number of quantization bits used per latent-space coefficient signaled by the network node 16 or implicitly defined by the deployed AI model, the WD 22 may be unable to fit the UCI payload by explicitly reducing the above parameters. In this scenario, an omission rule may be defined as in the legacy CSI report, so that bits, or CSI parts/sub-parts, with lower priority will be dropped/omitted first. This procedure is repeated until the UCI allocation is able to transmit the remaining CSI report with the required block error rate (BLER) target. The omission rule can be defined based on how the CSI report is segmented, as well as the report number. The CSI omission rules may only apply to Part 2 CSI and/or the sub-groups within the Part 2 CSI.
In at least one embodiment, a priority function Pri(.) can be defined for the bit sequence b_{AE}, where Pri(.) determines a priority level for each bit therein. The priority function Pri(.) may depend on one or subset of the following: transmission layer index, latent-space coefficient index (if known) of the AI model, group or sub-group index, etc. The following embodiments are non-limiting examples for each model ID and CSI report:

Example embodiments prioritizing partial knowledge about all layers:
In at least one embodiment, for a layer-common AI-based CSI feedback and for each reported bit in b_{AE}_{ₗ} in Group 1 of Part 2 CSI, a priority level is determined via the value of the following priority function, indexed by l:

$$Pri ( l ) = v \cdot {n}_{X}^{( l )} + l ,$$

where l=1, 2, . . . , v is the transmission layer index, v is the RI, b_{AE}_{ₗ} is the total bits corresponding to the l^{th} transmission layer,

$${n}_{X}^{( l )} ∈ \{ 0 , 1 , … , {N}_{X}^{( l )} - 1 \}$$

is the index of the latent-space coefficient with

$${N}_{X}^{( l )}$$

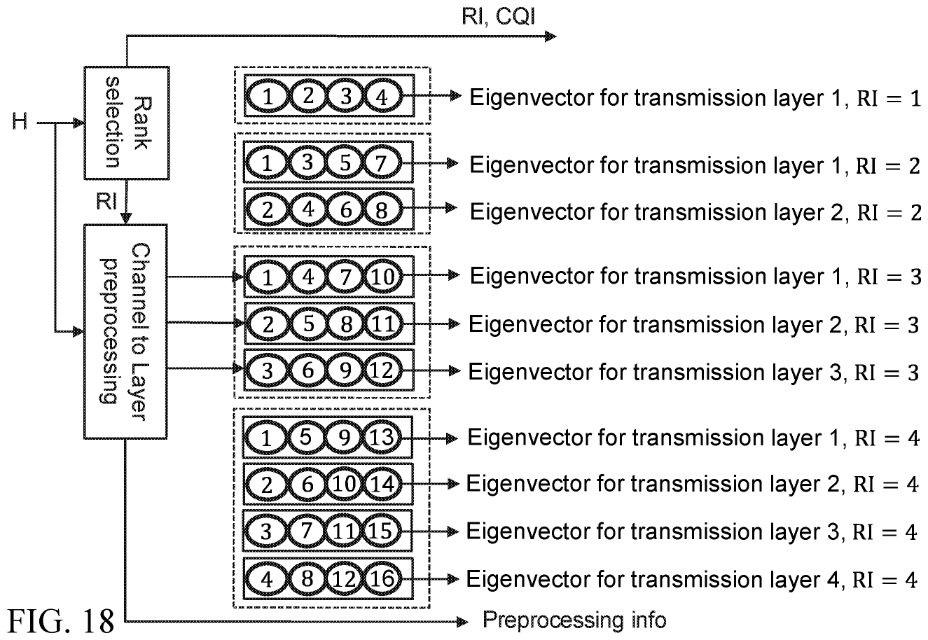

being the total number of latent-space coefficient associated for the l^{th} transmission layer, which may be either configured by the WD 22 or associated with model ID X. The element with the highest priority has the lowest associated value Pri(l). The priority rule allocates a descending order of the priority based on the index of the latent-space coefficient across all the transmission layers. The motivation behind the above priority rule is that network node 16 may be able to recover some Precoder Matrix Indicator (PMI) information for all the transmission layers at the output of the decoder even if some low priority bits are omitted. For example, after applying the priority rule, the wireless device 22 may feedback only the quantized output of first two latent-space coefficient configured for each transmission layer, which can be used as input to the decoder at the network node 16 to reconstruct some estimate of the PMI information. This embodiment is illustrated in FIG. 18.
In at least one embodiment, where the number of latent-space coefficients are not explicitly signaled, but the number of bits in b_{AE}_{ₗ} for l=1, 2, . . . , v in Group 1 of Part 2 CSI, a priority level is determined via the value of the following priority function, indexed by l:

$$Pri ( l ) = v \cdot {m}_{X}^{( l )} + l ,$$

where l=1, 2, . . . , v is the transmission layer index, vi is the RI, b_{AE}_{ₗ} is the total bits corresponding to the l^{th} transmission layer,

$${m}_{X}^{( l )} ∈ \{ 0 , 1 , … , {M}_{X}^{( l )} - 1 \}$$

is the index of the bit with

$${M}_{X}^{( l )}$$

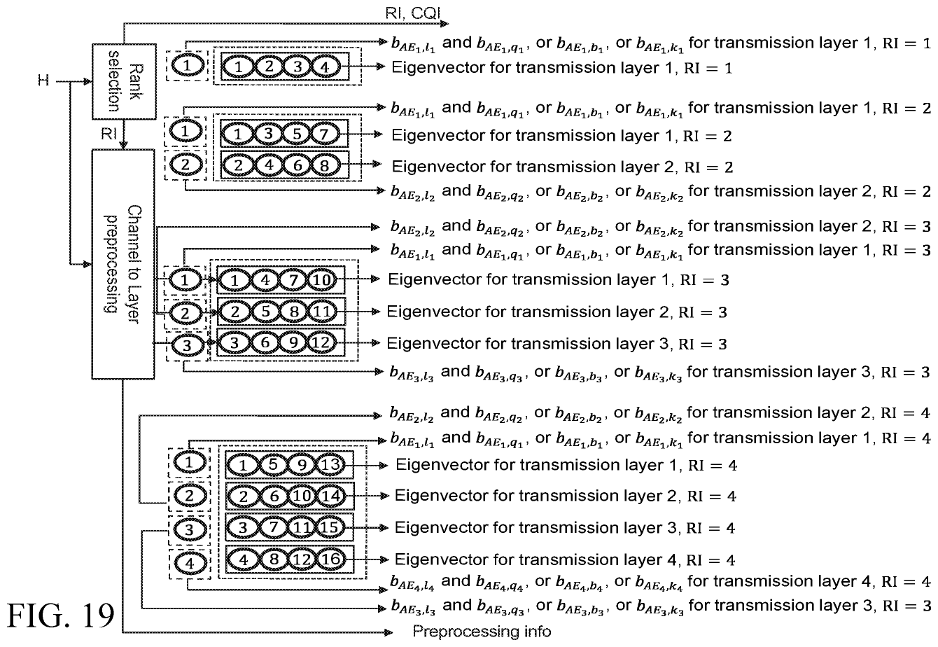

being the total number of bits associated for the l^{th} transmission layer, which is either configured by the WD 22 or associated with model ID X. The setting is similar to the embodiment of FIG. 18, but for the setting where the number of latent-space coefficients are not revealed, but only the total number of bits.
   In at least one embodiment, for a layer-specific AI-based CSI feedback and for each for each reported bits in b_{AE}_{ₗ} in Group 1 of Part 2 CSI, a priority level is determined via the value of the following priority function, indexed by {l, s_{g}}:

$$Pri ( l , {s}_{g} ) = l \cdot ( {s}_{g} < {S}_{g} ) + ( v \cdot {n}_{X}^{( l )} + l ) \cdot ( {s}_{g} > ( {S}_{g} - 1 ) ) ,$$

where s_{g}∈{1, 2, . . . , S_{g}} is the sub-group index with S_{g} being the total number of sub-groups per transmission layer, (s_{g}<S_{g})=1 if s_{g}<S_{g} or 0 otherwise, (s_{g}>(S_{g}−1))=1 if s_{g}>(S_{g}−1) or 0 otherwise, and the other parameters are as defined in the above embodiment. The rule follows the same motivation as the above embodiment, where additionally the bits corresponding in the sub-groups corresponding to auxiliary information is given the same priority as the bits corresponding to the first latent-space coefficient of each transmission layer. Accordingly, the bits in the sub-groups corresponding to auxiliary information contain information like number of active latent-space coefficients per transmission layer, number of quantization bits per latent-space coefficient, and/or the step size to determine the active latent-space coefficients per transmission layer. The embodiment is illustrated in FIG. 19.

Example embodiments prioritizing detailed knowledge about lower-numbered layers may include:
In at least one embodiment, for a layer-common AI-based CSI feedback and for each reported bit in b_{AEI} in Group 1 of Part 2 CSI, a priority level is determined via the value of the following priority function, indexed by l:

$$Pri ( l ) = {\sum }_{i = 1}^{l} {N}_{X}^{( i - 1 )} + {n}_{X}^{( l )} ,$$

where l=1, 2, . . . , v is the transmission layer index, n is the RI, b_{AE}_{ₗ} is the total bits corresponding to the l^{th} transmission layer,

$${n}_{X}^{( l )} ∈ \{ 1 , 2 , … , {N}_{X}^{( l )} \}$$

is the index of the latent-space coefficient with

$${N}_{X}^{( l )}$$

being the total number of latent-space coefficient associated for the l^{th} transmission layer with

$${N}_{X}^{( 0 )} = 0 ,$$

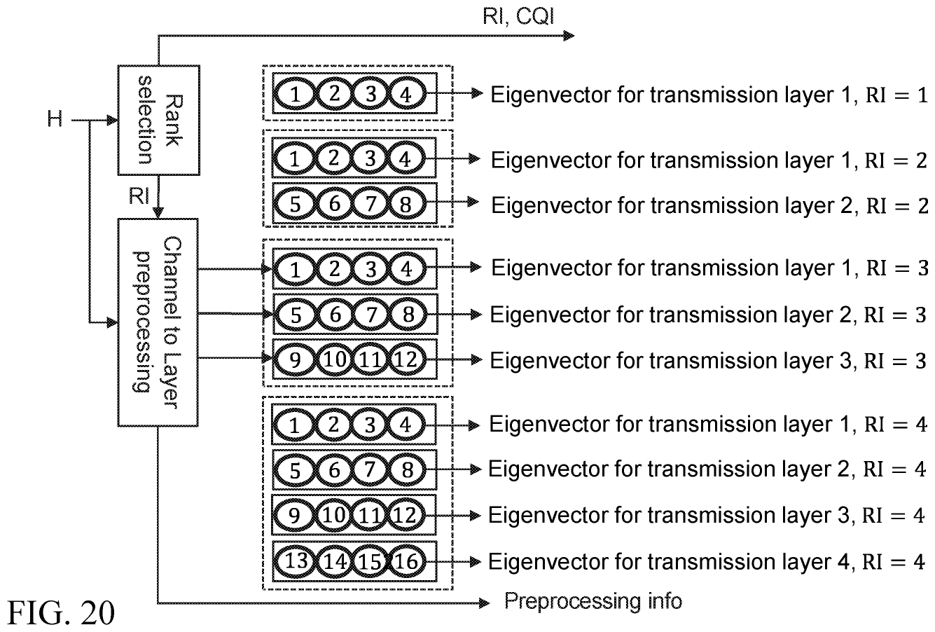

which is either configured for by the WD 22 or associated with model ID X. The element with the highest priority has the lowest associated value Pri(l). The priority rule allocates a descending order of the priority based on the index of the latent-space coefficient and the transmission layer index 1. The motivation behind the above priority rule is to allow the WD 22 to feedback all the bits for a lower transmission layer before moving to a higher transmission layer, such that the network node 16 can decode accurately the lower transmission layer at the output of the decoder even if the priority rule do not allow accurate estimation (or eliminate completely) of higher transmission layer. The embodiment is illustrated in FIG. 20.
In at least one embodiment, for a layer-specific AI-based CSI feedback and for each reported bits in b_{AE} in Group 1 of Part 2 CSI, a priority level is determined via the value of the following priority function, indexed by {l, s_{g}}:

$$Pri ( l , {s}_{g} ) = ( {s}_{g} < {S}_{g} ) + {\sum }_{i = 1}^{l} {N}_{X}^{( i - 1 )} + {n}_{X}^{( l )} \cdot ( {s}_{g} > ( {S}_{g} - 1 ) ) ,$$

where s_{g}∈{0, 1, . . . , S_{g}−1} is the sub-group index with S_{g} being the total number of sub-groups per transmission layer, (s_{g}<S_{g})=1 if s_{g}<S_{g} or 0, (s_{g}>(S_{g}−1))=1 if s_{g}>(S_{g}−1) or 0 otherwise, and the other parameters are as defined in the above embodiment. The rule follows the same motivation as the above embodiment, where additionally the bits corresponding to the sub-groups is given the same priority as the bits corresponding to the first latent-space coefficient of each transmission layer, similar to FIG. 19. Accordingly, the bits in the sub-groups corresponding to auxiliary information like number of active latent-space per transmission layer, number of quantization bits per latent coefficient, and/or the step size to determine the active latent-space per transmission layer are given same priority level.
In at least one embodiment, a group of bits in bE share the same priority level. For example, all bits associated with the same layer may have the same priority level.
In at least one embodiment, for explicit CSI feedback and for each reported bit in b_{AE}_{ₗ} in Group 1 of Part 2 CSI, a priority level can be determined via the value of the following priority function, indexed by the sub-segments s:

$$Pri ( s ) = s ,$$

Where b_{AE}_{ₗ} is the bits in each sub-segment and are generated by a single latent-space coefficient, are assigned the same priority. Note that the number of latent-space coefficients used at the output of the AE model at the WD 22 may be either configured for by the WD 22 or implicitly associated with model ID. The above priority rule allocates a descending order of the priority based on the sub-segment index or equivalently on the latent-space coefficient index. The motivation behind the above priority rule is that network node 16 may be able to recover some crude form of explicit CSI at the output of the decoder, even if some low priority bits are omitted. For example, after applying the priority rule, the WD 22 may feedback only the quantized output of first two latent-space coefficient (or first two sub-segments), which can be used as input to the decoder at the network node 16 to reconstruct some crude explicit CSI.

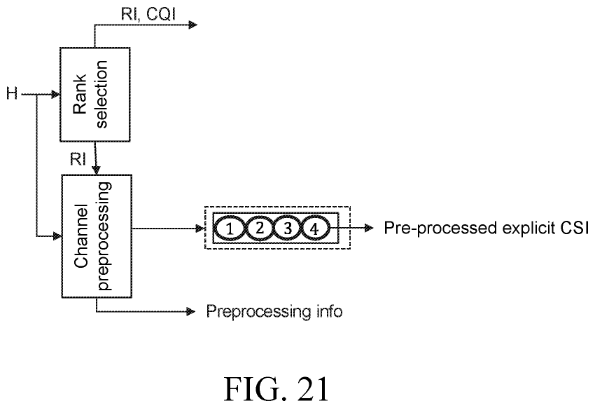

FIG. 21 illustrates a transmission model for explicit CSI feedback, where the pre-processed CSI is feedback with four latent-space coefficients with each latent-space coefficient representing a sub-segment. The numbers in each latent-space coefficient denotes the priority value assigned using Pri(s).

As described above, the WD 22 may reduce the size of the UCI report, e.g., by using the smaller quantization bits and/or smaller latent-space coefficient. Therefore, in an additional embodiment, a restriction in using the omission rule may also be applied, i.e., the WD 22 may only apply the omission rule when a certain condition is met. The condition may be, for example, the WD 22 should use the model(s), and/or quantization size(s), and/or latent-space coefficient(s) that in normal operation (without omission mechanism) result in the smallest possible UCI payload size for a given layer. In at least one embodiment, the WD 22 may be able to transmit UCI with 4 quantization bits or 8 quantization bits for each or all the layers. There, the WD 22 may only apply the omission rule when the WD 22 uses 4 quantization bits in the UCI report. Note that this restriction may be defined in an applicable standard, or may be proprietarily implemented by the WD 22.

The performance by reporting fewer bits than anticipated in CSI report (using any of the above-described omission methodologies) for a given transmission layer is evaluated. In at least one embodiment, the wireless device 22 may select the quantization-bit to fit the CSI payload and report the applied quantization-bit to the network node 16, i.e., to make sure that there will be an alignment between the AI-model on the wireless device 22 side and the AL-model on the network/network node 16 side. To enable this “adaptive” mechanism, the AI-model on both side (or one side) may be trained so that it can handle multiple possible quantization bit, i.e., during the training, the AI-models on both side (or one side) are trained with all possible quantization bit (denoted by ‘quantization common’ training).

In the tables below, the performance comparison of ‘quantization-specific’ training, where the AI-models on both side (or one side) are trained for a specific quantization bit, with the ‘quantization-common’ training is given. The performance is measured in terms of squared generalized cosine similarity (SGCS) for a single transmission layer. Table 2 shows the performance when the AI-models on both sides (network/network node 16 and wireless device 22) are trained jointly, whereas Table 3 shows the performance when the AI-model is trained sequentially and only one side (wireless device 22 side) is trained, i.e., the decoder from the previous training is used to train a completely new encoder. From the tables, it can be observed that the difference between the ‘quantization-specific’ and ‘quantization-common’ training is non-substantial. This means that the WD 22 may use different quantization bits to fit the CSI payload without much loss in the performance compared.

TABLE 2
SGCS of ‘quantization-specific’ vs ‘quantization-
common’ for the case of trainable AI-models at both
the NW/ network node 16 and WD 22

Quantization bits in
training and inference

| Training approach | 4 bits | 6 bits | 8 bits |
|---|---|---|---|
| Quantization-specific | 0.7528 | 0.7768 | 0.7902 |
| Quantization-common | 0.7530 | 0.7758 | 0.7809 |

TABLE 3
SGCS of quantization-specific vs quantization-common
for the case of trainable AI-model only at the WD 22

Quantization bits in
training and inference

| Training approach | 4 bits | 6 bits | 8 bits |
|---|---|---|---|
| Quantization-specific | 0.7532 | 0.7742 | 0.7887 |
| Quantization-common | 0.7528 | 0.7758 | 0.7808 |

At least one embodiment relates to the methodology for the reduction/omission of bits for AI-based CSI feedback on the UCI, where the wireless device 22 processes the eigenvectors per transmission layer or the estimated explicit CSI with an AI model to generate the CSI report.

Example 1: A method wherein the WD 22 reports an AI-based CSI report on UCI, where the generation of the CSI report includes either extracting the raw or the pre-preprocessed eigenvectors per transmission layer from the estimated channel or the estimated explicit CSI, and where:
The network node 16 configures the CSI payload and signals it to the WD 22.
If the AI-based CSI report is larger than the CSI payload, the WD 22 can omit bits from the CSI report to fit the CSI payload.

Example 2: The method of Example 1, wherein the CSI omission rule can be:
Configured by the WD 22 and implicitly signaled to the network node 16 through the dependent parameters, like the number of active latent-space coefficients at the output of the AI model at the WD 22, and the number of quantization bits for each latent-space coefficient, on the UCI.
Depending on pre-defined priority function, which is determined based on one or more of, 1) transmission rank, 2) transmission layer, 3) number of latent-space coefficients per transmission layer at the output of the AI model at the WD 22, 4) index of each latent-space coefficient per transmission layer at the output of the AI model at the WD 22 and/or 5) segmentation of bits within CSI Part 2.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

The following is a nonlimiting list of example embodiments

Embodiment A1. A network node configured to communicate with a wireless device (WD), the network node configured to, and/or comprising a radio interface and/or comprising processing circuitry configured to:
configure the wireless device with a channel state information, CSI, payload size;
receive an artificial intelligence-based (AI-based) CSI report, the CSI report being generated by omitting a plurality of bits according to an omission rule such that the CSI report has a size less than or equal to the CSI payload size; and
perform at least one action based on the received CSI report.

Embodiment A2. The network node of Embodiment A1, wherein the omission rule is configured by the wireless device and includes at least one of:
a number of active latent-space coefficients at an output of an AI model used to generate the CSI report; and
a number of quantization bits for each of a plurality of latent-space coefficients corresponding to uplink control information, UCI.

Embodiment A3. The network node of Embodiment A1, wherein the omission rule corresponds to a pre-defined priority function, the pre-defined priority function being based on one or more of
a transmission rank;
a transmission layer;
a number of latent-space coefficients per transmission layer at an output of an AI model used to generate the CSI report;
an index of each latent-space coefficient per transmission layer at the output of the AI model at the wireless device; and
a segmentation of bits within CSI Part 2.

Embodiment B1. A method implemented in a network node, the method comprising:
configuring the wireless device with a channel state information, CSI, payload size;
receiving an artificial intelligence-based (AI-based) CSI report, the CSI report being generated by omitting a plurality of bits according to an omission rule such that the CSI report has a size less than or equal to the CSI payload size; and
performing at least one action based on the received CSI report.

Embodiment B2. The method of Embodiment B1, wherein the omission rule is configured by the wireless device and includes at least one of
a number of active latent-space coefficients at an output of an AI model used to generate the CSI report; and
a number of quantization bits for each of a plurality of latent-space coefficients corresponding to uplink control information, UCI.

Embodiment B3. The method of Embodiment B1, wherein the omission rule corresponds to a pre-defined priority function, the pre-defined priority function being based on one or more of
a transmission rank;
a transmission layer;
a number of latent-space coefficients per transmission layer at an output of an AI model used to generate the CSI report;
an index of each latent-space coefficient per transmission layer at the output of the AI model at the wireless device; and

Embodiment C1. A wireless device (WD) configured to communicate with a network node, the WD configured to, and/or comprising a radio interface and/or processing circuitry configured to:
receive a configuration for a channel state information, CSI, payload size;
generate an artificial intelligence-based (AI-based) CSI report, the CSI report being generated by omitting a plurality of bits according to an omission rule such that the CSI report has a size less than or equal to the CSI payload size; and
transmit the CSI report to the network node.

Embodiment C2. The WD of Embodiment C1, wherein the omission rule is configured by the wireless device and includes at least one of:
a number of active latent-space coefficients at an output of an AI model used to generate the CSI report; and
a number of quantization bits for each of a plurality of latent-space coefficients corresponding to uplink control information, UCI.

Embodiment C3. The WD of Embodiment C1, wherein the omission rule corresponds to a pre-defined priority function, the pre-defined priority function being based on one or more of:
a transmission rank;
a transmission layer;
a number of latent-space coefficients per transmission layer at an output of an AI model used to generate the CSI report;
an index of each latent-space coefficient per transmission layer at the output of the AI model at the wireless device; and

Embodiment D1. A method implemented in a wireless device (WD), the method comprising:
receiving a configuration for a channel state information, CSI, payload size;
generating an artificial intelligence-based (AI-based) CSI report, the CSI report being generated by omitting a plurality of bits according to an omission rule such that the CSI report has a size less than or equal to the CSI payload size; and
transmitting the CSI report to the network node.

Embodiment D2. The method of Embodiment D1, wherein the omission rule is configured by the wireless device and includes at least one of
a number of active latent-space coefficients at an output of an AI model used to generate the CSI report; and
a number of quantization bits for each of a plurality of latent-space coefficients corresponding to uplink control information, UCI.

Embodiment D3. The method of Embodiment D1, wherein the omission rule corresponds to a pre-defined priority function, the pre-defined priority function being based on one or more of
a transmission rank;
a transmission layer;
a number of latent-space coefficients per transmission layer at an output of an AI model used to generate the CSI report; and
an index of each latent-space coefficient per transmission layer at the output of the AI model at the wireless device.

1.-24. (canceled)

25. A method implemented by a wireless device, WD, the method comprising:
receiving, from a network node, a configuration for a channel state information, CSI, payload size; and
transmitting, to the network node, a CSI report, the CSI report having been generated by omitting a plurality of bits according to an omission rule such that the CSI report has a size less than or equal to the CSI payload size.

26. The method of claim 25, further comprising generating an artificial intelligence-based, AI-based, CSI report.

27. The method of claim 25, wherein the omission rule is configured by the WD and the omission rule includes at least one of:
a number of active latent-space coefficients at an output of an AI model used to generate the CSI report; and
a number of quantization bits for each of a plurality of latent-space coefficients corresponding to uplink control information, UCI.

28. The method of claim 25, wherein the omission rule corresponds to a pre-defined priority function, the pre-defined priority function being based on one or more of:
a transmission rank;
a transmission layer;
a number of latent-space coefficients per transmission layer at an output of an A1 model used to generate the CSI report;
an index of each latent-space coefficient per transmission layer at the output of the A1 model at the WD; and
a segmentation of bits within Part 2 of the generated CSI report, wherein the generated CSI report includes a Part 1 and a Part 2.

29. The method of claim 25, further comprising signaling, to the network node, the omission rule.

30. A wireless device, WD, configured to communicate with a network node, the WD configured to:
receive, from the network node, a configuration for a channel state information, CSI, payload size; and
transmit, to the network node, the CSI report, the CSI report having been generated by omitting a plurality of bits according to an omission rule such that the CSI report has a size less than or equal to the CSI payload size.

31. The WD of claim 30, further configured to generate an artificial intelligence-based, AI-based, CSI report.

32. The WD of claim 30, wherein the omission rule is configured by the WD and the omission rule includes at least one of:
a number of active latent-space coefficients at an output of an AI model used to generate the CSI report; and
a number of quantization bits for each of a plurality of latent-space coefficients corresponding to uplink control information, UCI.

33. The WD of claim 30, wherein the omission rule corresponds to a pre-defined priority function, the pre-defined priority function being based on one or more of:
a transmission rank;
a transmission layer;
a number of latent-space coefficients per transmission layer at an output of an A1 model used to generate the CSI report;
an index of each latent-space coefficient per transmission layer at the output of the A1 model at the WD; and
a segmentation of bits within a Part 2 of the generated CSI report, wherein the generated CSI report includes a Part 1 and the Part 2.

34. The WD of claim 30, further configured to signal, to the network node, the omission rule.

35. A method implemented by a network node, the method comprising:
configuring a wireless device, WD, with a channel state information, CSI, payload size;
receiving, from the WD, a CSI report, the CSI report having a size less than or equal to the CSI payload size; and
performing at least one action based on the received CSI report.

36. The method of claim 35, wherein the received CSI report is an artificial intelligence-based, AI-based, CSI report.

37. The method of claim 35, wherein the at least one action comprises decoding the received CSI report.

38. The method of claim 35, wherein the CSI report is generated by the WD by omitting a plurality of bits according to an omission rule, the omission rule is configured by the WD and the omission rule includes at least one of:
a number of active latent-space coefficients at an output of an AI model used to generate the CSI report; and
a number of quantization bits for each of a plurality of latent-space coefficients corresponding to uplink control information, UCI.

39. The method of claim 38, wherein the omission rule corresponds to a pre-defined priority function, the pre-defined priority function being based on one or more of:
a transmission rank;
a transmission layer;
a number of latent-space coefficients per transmission layer at an output of an A1 model used to generate the CSI report;
an index of each latent-space coefficient per transmission layer at the output of the A1 model at the WD; and
a segmentation of bits within a Part 2 of the generated CSI report, wherein the generated CSI report includes a Part 1 and the Part 2.

40. The method of claim 38, further comprising receiving, from the WD, the omission rule.

41. A network node configured to communicate with a wireless device, WD, the network node configured to:
configure the WD with a channel state information, CSI, payload size;
receive, from the WD, a CSI report, the CSI report having a size less than or equal to the CSI payload size; and
perform at least one action based on the received CSI report.

42. The network node of claim 41, wherein the received CSI report is an artificial intelligence-based, AI-based, CSI report.

43. The network node of claim 41, wherein the CSI report is generated by the WD by omitting a plurality of bits according to an omission rule, the omission rule is configured by the WD and the omission rule includes at least one of:
a number of active latent-space coefficients at an output of an AI model used to generate the CSI report; and
a number of quantization bits for each of a plurality of latent-space coefficients corresponding to uplink control information, UCI.

44. The network node of claim 43, further configured to receive, from the WD, the omission rule.
